(19) United States
(12) Patent Application Publication
(10) Pub. No.: US 2011/0238534 A1
(43) Pub. Date: Sep. 29, 2011

(54) METHODS AND SYSTEMS FOR IMPROVING THE CATEGORIZATION OF ITEMS FOR WHICH ITEM LISTINGS ARE MADE BY A USER OF AN ECOMMERCE SYSTEM

(76) Inventor: Ramanjaneyulu Yakkala, San Jose, CA (US)

(21) Appl. No.: 12/749,458

(22) Filed: Mar. 29, 2010

(51) Int. Cl. G06Q 30/00; G06F 3/048

(52) U.S. Cl. 705/27.1; 715/810

(57) ABSTRACT

Methods and systems for improving the classification of items that are listed for sale on an ecommerce system. In one example embodiment a seller of an item provides the ecommerce system a listing of the item for sale, the listing including key data such as item category in textual format. The ecommerce system, in response to the textual category, presents to the seller images of types of the item in the category in silhouette form. The seller selects the silhouette delineating the type of item, causing the type of item to be entered as key data in the listing. The seller may send her own image of the item to the system, which then compares the seller-provided image to a system image of known category and/or type. If the system detects a possible mismatch between the images, the system provides feedback to the seller indicating a possible error in categorization of the listed item.

### TECHNICAL FIELD

The present disclosure generally relates to data processing techniques. More specifically, the present disclosure relates to methods and systems for improving how items are listed for sale on a computer-based trading or e-commerce application.

### BACKGROUND

Advancements in computer and networking technologies have enabled persons to conduct commercial and financial transactions “on-line” via computer-based applications. This has given rise to a new era of electronic commerce (often referred to as e-commerce.) A number of well-known retailers have expanded their presence and reach by operating websites that facilitate e-commerce. In addition, many new retailers, which operate exclusively online, have come into existence. The business models utilized by enterprises operating online are almost as varied as the products and services offered. For instance, some products and services are offered at fixed prices, while others are offered via various auction methods, and still others are offered via a system of classified ad listings. Some enterprises specialize in the selling of a specific type of product (e.g., books) or a specific service (e.g., tax preparation), while others provide a myriad of categories of items and services from which to choose. Some enterprises serve only as an intermediary, connecting sellers and buyers, while others sell directly to consumers.

Despite the many technical advances that have improved the state of e-commerce, a great number of technical challenges and problems remain. One such problem involves determining how to minimize the opportunity for error when presenting products and services (e.g., items) that are being offered for sale to a prospective buyer, so as to maximize the likelihood that a transaction (e.g., the sale of a product or service) will occur. One type of error that can occur is a miscategorization of the product or service at the time it is listed on the ecommerce system. If mischaracterization occurs at listing, then, when a potential buyer performs a search for that category of product or service, it may be the case that an incorrect item is presented on a search results page, which can affect whether potential buyers ultimately purchase the listed product or service.

### DESCRIPTION OF THE DRAWINGS

Some embodiments are illustrated by way of example and not limitation in the figures of the accompanying drawings, in which:

FIG. 1 shows a schematic block diagram of an exemplary network-based commerce system, in accordance with the invention.

FIG. 1A is a server system useful in one embodiment, which may be resident in the commerce system of FIG. 1.

FIG. 2 shows exemplary tables of a database of the system of FIG. 1.

FIG. 3 shows an exemplary listings table of the database of FIG. 2.

FIG. 4 shows a schematic flow diagram of a method, in accordance with the invention, to generate a listing in a network-based commerce system.

FIG. 5 illustrates one embodiment for minimizing opportunity for error in a listing.

FIG. 6 is an illustration of product images in silhouette form useful in one embodiment.

FIG. 7 is a block diagram of a machine, which may be in the form of a mobile device, within which a set of instructions for causing the machine to perform any one or more of the methodologies discussed herein may be executed.

### DETAILED DESCRIPTION

Methods and system automatically generating listings in network-based commerce system based on reference listing data is described in the above related application. In the following description, for purposes of explanation, numerous specific details are set forth in order to provide a thorough understanding of the invention. It will be evident, however, to one skilled in the art that the invention may be practiced without these specific details. For the purposes of the present specification, the term “item” may refer to any description, identifier, representation or information, including a title, a picture, or an image related to or pertaining to a listing, service, offering or request that is stored within a network based commerce system. As such, a listing may be an auction or fixed-price offering (e.g., products such as goods and/or services), an advertisement, or a request for a listing or service.

### Transaction Facility

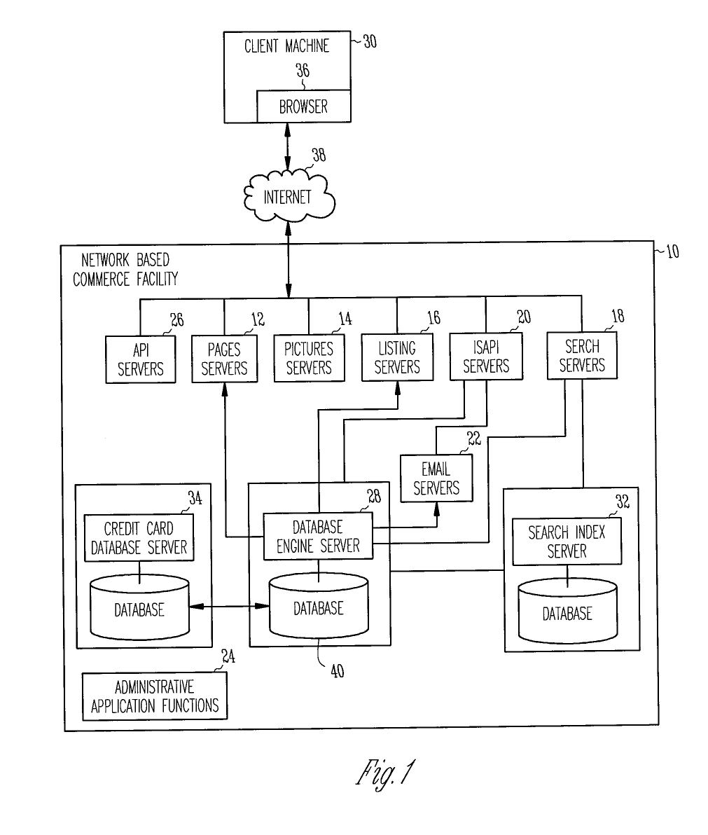

FIG. 1 is block diagram illustrating an exemplary network-based commerce system 10. While an exemplary embodiment of the present invention is described within the context of the network-based commerce system 10, the invention will find application in many different types of computer based, and network-based, facilities (commerce, transaction or otherwise).

The network-based commerce system 10 includes one or more of a number of types of front-end servers that each includes at least one Dynamic Link Library (DLL) to provide selected functionality. The system 10 includes page servers 12 that deliver web pages (e.g., mark-up language documents), picture servers 14 that dynamically deliver images to be displayed within Web pages, listing servers 16 that facilitate category-based browsing of listings, search servers 18 that handle search requests to the system 10 and facilitate keyword based browsing of listings, and ISAPI servers 20 that provide an intelligent interface to a back-end of the system 10. The system 10 also includes e-mail servers 22 that provide, inter alia, automated e-mail communications to users of the network-based commerce system 10. In one embodiment, one or more administrative application functions 24 facilitate monitoring, maintaining, and managing the system 10. One or more API servers 26 may provide a set of API functions for querying and writing to the network-based commerce system 10. APIs may be called through the HTTP transport protocol. In one embodiment, information is sent and received using a standard XML data format. Applications utilized to interact (e.g., upload transaction listings, review transaction listings, manage transaction listings, etc.) with the network-based commerce system 10 may be designed to use the APIs. Such applications may be in an HTML form or be a CGI program written in C++, Perl, Pascal, or any other programming language.

The page servers 12, API servers 26, picture servers 14, ISAPI servers 20, search servers 18, e-mail servers 22 and a database engine server 28 may individually, or in combination, act as a communication engine to facilitate communications between, for example, a client machine 30 and the network-based commerce system 10; act as a transaction engine to facilitate transactions between, for example, the client machine 30 and the network-based commerce system 10; and act as a display engine to facilitate the display of listings on, for example, the client machine 30.

The back-end servers may include the database engine server 28, a search index server 32 and a credit card database server 34, each of which maintains and facilitates access to a respective database.

In one embodiment, the network-based commerce system 10 is accessed by a client program, such as for example a browser 36 (e.g., the Internet Explorer distributed by Microsoft Corp. of Redmond, Wash.) that executes on the client machine 30 and accesses the network-based commerce system 10 via a network such as, for example, the Internet 38. Other examples of networks that a client may utilize to access the network-based commerce system 10 include a wide area network (WAN), a local area network (LAN), a wireless network (e.g., a cellular network), the Public Switched Telephone Network (PSTN) network, or the like. The client program that executes on the client machine 30 may also communicate with the network-based commerce system 10 via the API servers 26.

Illustrated in FIG. 1A is server system 15 which could be resident in the transaction system 10. The server system 15, which could be part of, or coupled to, listing server 16 of FIG. 1, is shown to include an on-line trading application 17. In this example, the online trading application 17 is comprised of two primary modules—an on-line trading engine module 19, and an item listing presentation management module 21 for presenting listings to the user. The presentation management module 21 may also be used in the process of generating a listing by a seller.

In some embodiments, the on-line trading engine module 19 may consist of a variety of sub-components or modules, which provide some of the functions of an on-line trading application 17. Each module may be comprised of software instructions, computer hardware components, or a combination of both. To avoid obscuring the invention in unnecessary detail, only a few of the on-line trading engine functions (germane to the invention) are described herein. For example, the on-line trading engine module 19 may include an item listing management module (not shown) that facilitates the receiving and storing of data representing item attributes, which collectively form an item listing. When a user desires to list a single item, or multiple items, for sale, the user will provide information about the item(s) (e.g., item attributes). Such information may be submitted via one or more forms of one or more web pages, or via drop down lists, or similar user interface elements. The item listing management module receives the item attributes and stores the item attributes together within a database 25 as an item listing 27. In some instances, the item listings may be stored in an item listing database table. The item listing management module may also communicate with a seller in the process of generating a listing and entering the listing into the database 25. Also included in database 25 could be images for use in the process of generating the listing.

### Database Structure

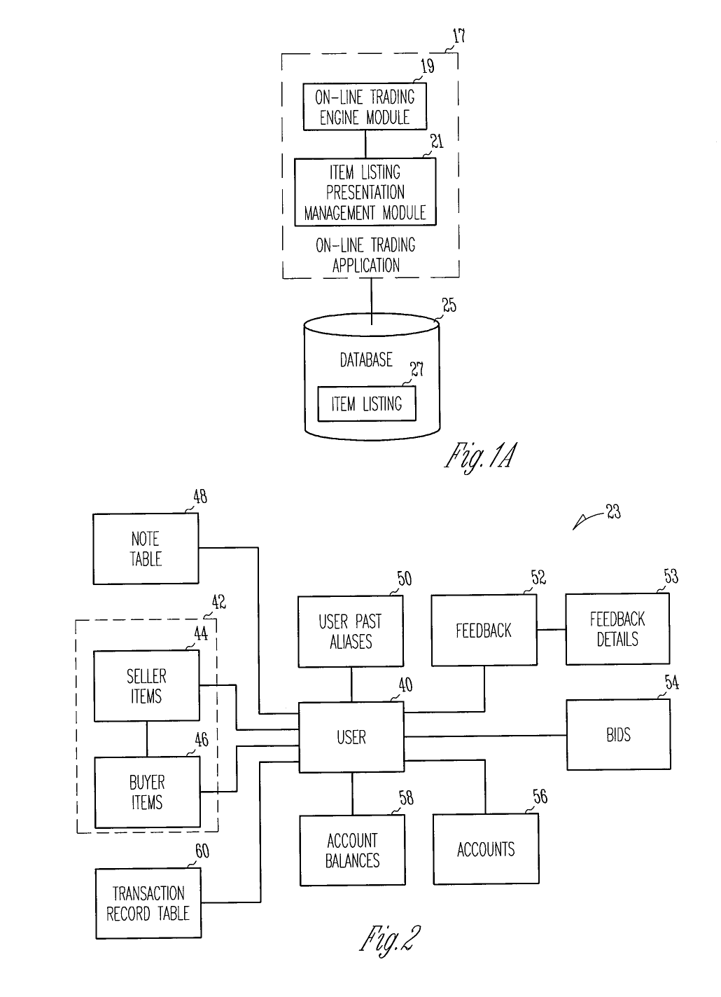

FIG. 2 is a database diagram illustrating an exemplary database 40, maintained by and accessed via the database engine server 28, which at least partially implements and supports the network-based commerce system 10. In one embodiment, the database engine server 28 may maintain two databases, a first database being maintained for listing (or offering) information that is not included within a virtual “store”, and a second database for listing (or offering) information that is presented via a virtual “store” supported by the network-based commerce system 10.

The database 40 may, in one embodiment, be implemented as a relational database, and includes a number of tables having entries, or records, that are linked by indices and keys. In an alternative embodiment, the database 40 may be implemented as collection of objects in an object-oriented database.

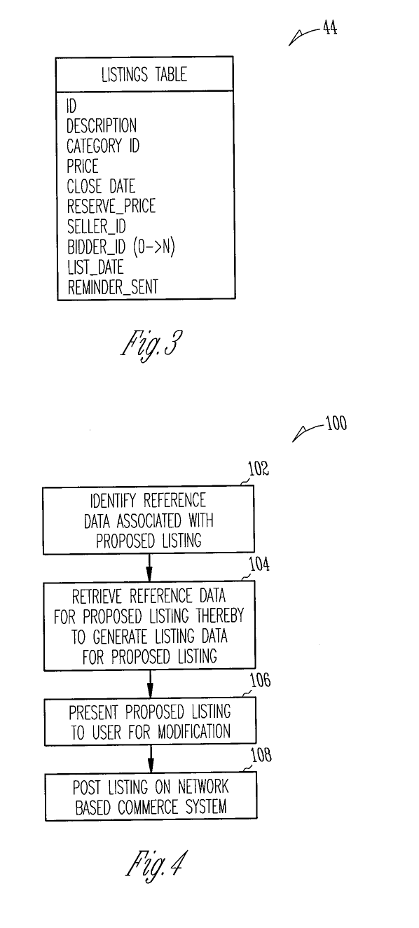

The database 40 (see FIG. 2) includes a user table 42 that contains a record for each user of the network-based commerce system 10. A user may operate as a seller, a buyer, or both, when utilizing the network-based commerce system 10. The database 40 also includes listings tables 44 that may be linked to the user table 42. The listings tables 44 may include a seller listings table 46 and a bidder listings table 48. A user record in the user table 42 may be linked to multiple listings that are being, or have been, listed or offered for sale via the network-based commerce system 10. In one embodiment, a link indicates whether the user is a seller or a bidder (or buyer) with respect to listings for which records exist within the listings tables 44. An exemplary listings table is also shown in FIG. 3.

The database 40 also includes one or more divisions in the form of categories provided in category table 50. Each record within the category table 50 may describe a respective category. In one embodiment, listings provided by the system 10 are arranged in the categories. These categories may be navigable by a user of the network-based commerce system 10 to locate listings in specific categories. Thus, categories provide a mechanism to locate listings that may be browsed. In addition or instead, an alphanumeric search mechanism may be provided by the search servers 18 to allow a user to search for specific listings using search terms or phrases. In one embodiment, the category table 50 describes multiple, hierarchical category data structures, and includes multiple category records, each of which describes the context of a particular category within the multiple hierarchical category structures. For example, the category table 50 may describe a number of real, or actual, categories to which listing records, within the listings tables 44, may be linked.

The database 40 also includes one or more attributes tables 52. Each record within the attributes table 52 describes a respective attribute associated with a listing. In one embodiment, the attributes table 52 describes multiple, hierarchical attribute data structures, and includes multiple attribute records, each of which describes the context of a particular attribute within the multiple hierarchical attribute structures. For example, the attributes table 52 may describe a number of real, or actual, attributes to which listing records, within the listings tables 44, may be linked. Also, the attributes table 52 may describe a number of real, or actual, attributes to which categories, within the category table 50, may be linked.

The database 40 may also include a note table 54 populated with note records that may be linked to one or more listing records within the listings tables 44 and/or to one or more user records within the user table 42. Each note record within the note table 54 may include, inter alia, a comment, description, history or other information pertaining to a listing being offered via the network-based commerce system 10, to a user of the network-based commerce system 10. The database 40 may also include a targeted site table 56 populated with targeted site records that may be linked to one or more listing records within the listings tables 44 and/or to one or more user records within the user table 42.

A number of other exemplary tables may also be linked to the user table 42, namely a user past aliases table 58, a feedback table 60, a feedback details table 62, a bids table 64, an accounts table 66, and an account balances table 68. In one embodiment, the database 40 also includes a batch table 70, a batch listings table 72, and a listings wait table 74.

### Generating a Listing

Referring in particular to FIG. 4, reference numeral 100 generally indicates a method, in accordance with the invention, of generating a listing in the exemplary network-based commerce system 10. In one embodiment, the method 100 automatically populates fields (e.g., includes listing information) of a listing submitted to the network-based commerce system 10 by a user. Although the method 100 may be used to post listings for any type of listing (e.g., products including goods and/or services, advertisements, and so on) its application in posting listings for the sale of clothing, shoes and accessories in an auction based commerce system is described herein by way of example.

As shown at Block 102, the method 100, broadly, identifies reference data, including textual data and at least one image, associated with the proposed listing and, thereafter, retrieves the reference listing data for the proposed listing from a reference data store and then, in an automated fashion, generates listing data for the proposed listing (see block 104) based on the reference listing data. As will be described in more detail below, the method 100 then presents the proposed listing to the user and allows the user to modify (e.g., edit) the data or information in the proposed listing (see block 106). In one embodiment, the method 100 pre-populates fields of a web page with appropriate data that has been retrieved and then allows the user to modify the data as required. Once the proposed listing has been finalized (and/or accepted) by the user, it may then be posted on the network-based commerce system 10 as shown at block 108.

When the method 100 is applied to listings in the form of clothing, shoes or accessories, (including items like shoes, handbags, shorts, tops, and the like) a title of the item, such as “woman's shoe, flat” may be used to identify the appropriate reference data or information associated with the listing (see block 102). Other information such as fabric, color, size, price, and the like, may also be used. Thus, key data associated with the particular listing (e.g., the woman's shoe) is provided to the user who wishes to list the woman's shoe in an automated fashion. Accordingly, in one embodiment, a user posting a listing will enter appropriate information, the type of which could be presented to the user to select, when listing (e.g., selling a woman's shoe) via the network-based commerce system 10. In one embodiment, the method 100 generates a template suitable for selling the particular type of woman's shoe and the template is then populated with the appropriate reference data identified.

### Minimizing Opportunity for Error

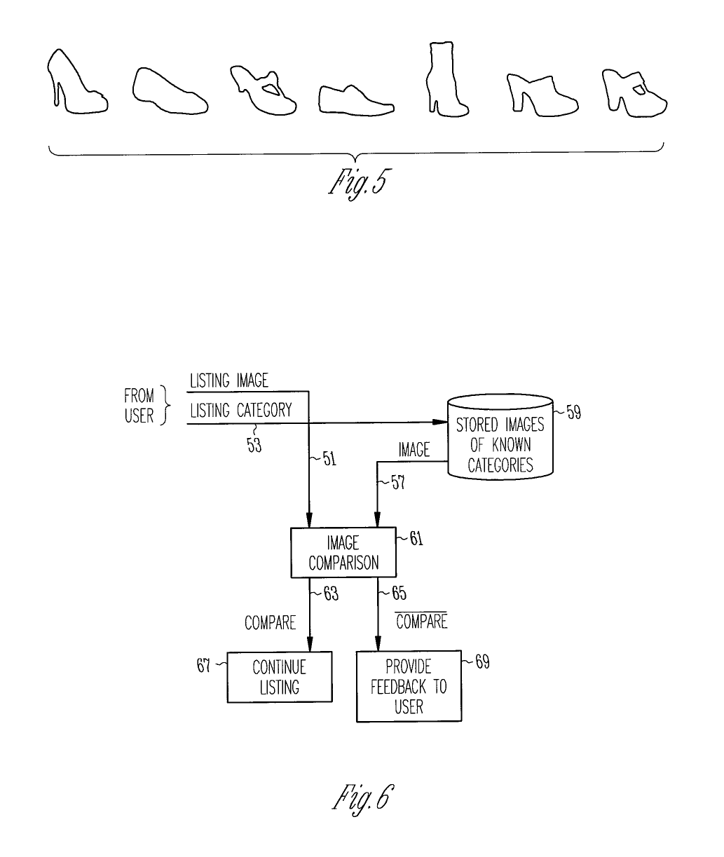

It will be appreciated that the success of a seller in selling a listed item may be dependent upon the listing information provided when the listing is posted to the network-based commerce system. In this regard it can be important to minimize the opportunity for error, or error rate, when listing an item for sale. In one embodiment, the silhouette images described in U.S. patent application Ser. No. 60/______, Applicant File 2043.821PRV, filed on even date herewith and incorporated by reference herein, could be used for this purpose. For example, the seller may list an item which is a woman's shoe, and sends the key data listing information (woman's shoe) to the facility 10, as at 102. As one modification of the automated listing discussed above, and in an effort to make sure the seller identifies the proper style of shoe quickly and also to minimize the opportunity for error, in response to the listing's key data going to woman's shoes, the facility could present to the listing seller various silhouettes of woman's shoes as seen in FIG. 5. The seller could then easily select the appropriate type of woman's shoe being listed and transmit this to facility 10 as additional key data. For example, the listing seller could click on the proper silhouette, selecting it as the appropriate style. If the woman's shoe the seller is listing is a flat, as above, the seller can click on the silhouette delineating a flat in FIG. 5. This information would then be entered into the listing as explained above. This allows the seller to make the listing quickly and with less chance for listing error since the seller sees the silhouette visually. One of ordinary skill in the art will recognize that the image can be in other than silhouette form without departing from the spirit or the scope of the invention.

As a check on the accuracy of the listing being made, a modification can be made to the process explained next above. Before entering information into the listing, the system could check key data supplied by the seller, such as “woman's shoe, flat” (which might be transmitted by the seller at any point in the process) against the silhouette chosen by the seller. If the key data provided by the seller doesn't match the silhouette chosen by the seller, the system can provide feedback to the seller, such as a comment asking whether the seller is sure she is selling a flat. Other feedback discussed below could also be presented to the seller at this point.

As a further check on the accuracy of the listing, the seller may also send the system an image of the particular shoe that is being listed. The system, knowing the selection of the shoe type the seller has already made (woman's shoe, flat), may perform an image comparison between an image of the listed product sent by the seller and an image known be the image of a flat in the system database. Image comparison can be implemented as seen in U.S. patent application Ser. No. ______ filed on even date herewith and incorporated herein by reference. If there is in indication that the two images may not compare, the system, again, can send feedback to the listing seller asking whether the seller has correctly listed the item.

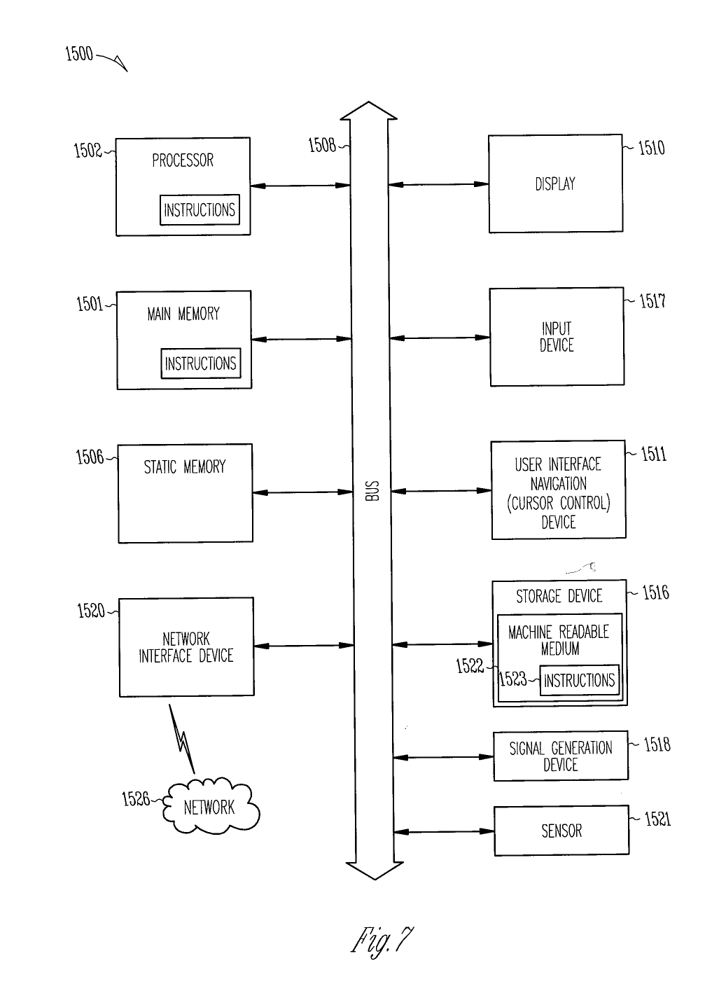

This is seen diagrammatically in one embodiment in FIG. 6. In that figure, at least one image of the item provided for listing by the seller is transmitted over line 51 to image comparison function 61. The listing category the user has provided for the item, for example, “woman's shoe, flat” can be provided over line 53. Database 59, which could be an appropriate one of the databases of FIG. 1, stores images of known categorization. As one example, the address of a given image in the database could be the address signified by its known category, or a hash thereof. For example, the image of a flat could be stored at an address indicated by “woman's shoe, flat”, or a hash thereof. Access addressing schemes are well known in the art and there can be any one of any number of well known such access address schemes, so the actual access scheme used is not limited to the foregoing access scheme. The category corresponding to the listing image for the listing category, in this example “woman's shoe, flat” would then be provided over line 53 and can access the image stored in the database 59 at the address indicated by “woman's shoe, flat” or a hash thereof, as the case may be. The image in database 59 that corresponds to the category on line 53 would then be read out of database 59 over line 57 and sent to image comparison 61. Another image comparison device that could be used for this embodiment, depending on the types of images being compared, could be similar to that disclosed in U.S. patent application Ser. No. 11/684,449 filed Mar. 9, 2007 and incorporated herein by reference. If the two images over lines 51 and 57 compare, as at line 63, the system has not detected a possible listing categorization error and the listing is allowed to continue, as at 67. However, if there has been a listing categorization error, the wrong category of image will be sent over line 53 and two images will not compare, as at line 65. At that point the system has detected a possible listing categorization error and can provide feedback to the user, as at 69. The feedback could ask, for example, whether the user has included the intended image for the listing category. The user can then provide the proper image and the function can proceed once again. Any control scheme desired can be implemented. For example, if after a given number of attempts a comparison is not achieved, the user can be locked out from listing the item. Alternatively, the system owner may not want to implement such a sharp cutoff and may merely refer the user to system support to resolve the matter, or other appropriate remedial processes. Other alternatives could be used without departing from the spirit and the scope of the invention.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Example Computer System

FIG. 7 is a block diagram of a machine in the form of a mobile device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environments, or as a peer machine in peer-to-peer (or distributed) network environments. The machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device (e.g., drive unit 1516), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A computer implemented method for improving the categorizing of an item in a listing of the item for sale on an ecommerce system, the method comprising:
receiving from a seller information delineating the category of the item;
in response to the information, presenting the seller with a plurality of possible images that illustrate the type of the item in the delineated category;
receiving from the seller a selection of one of the plurality of possible images; and
responsive to receiving the selection, populating the listing with an image of an item of the type offered for sale by the seller.

2. The method of claim 1 further including providing the plurality of possible images in silhouette form.

3. A non-transitory computer-readable storage medium with an executable program stored thereon, wherein the program, when executed, instructs one or more computer processors to generate an item listing by performing the following method:
receiving from a seller information delineating the category of the item;
in response to the information, presenting the seller with a plurality of possible images that illustrate the type of the item in the delineated category;
receiving from the seller a selection of one of the plurality of possible images; and
responsive to receiving the selection, populating the listing with an image of an item of the type offered for sale by the seller.

4. The non-transitory computer-readable medium of claim 3 including providing the plurality of possible images in silhouette format.

5. A system for improving the categorization of an item in a listing of the item for sale on an ecommerce system, the system comprising:
a listing server for receiving from a seller information delineating the category of the item;
an item listing presentation management module coupled to the listing server to present to the seller, in response to the information, a plurality of possible images that illustrate the type of the item of the delineated category; and
a listing management module for receiving from the seller a selection of one of the plurality of possible images and, in response to the selection, populating the listing with an image of an item of the type offered for sale by the seller.

6. A computer implemented method for improving the categorizing of an item in a listing of the item for sale on an ecommerce system, the method comprising:
receiving from a seller information delineating the category of the item, the item including an image of the item;
making an image comparison of the image of the item against an image of an item known to be of the delineated category;
detecting whether there is a mismatch between the image of the listed item and the image of the item known to be of the delineated category; and
responsive to the detection of a mismatch, providing feedback to the seller indicating a possible error in categorizing the listed item.

7. The method of claim 6 wherein at least one of the images is in silhouette form.

8. The method of claim 6 wherein the included image of the item is used in accessing the image of the item known to be of the delineated category.

9. The method of claim 6 wherein the image of the item known to be of the delineated category is stored in a database within the ecommerce system.

10. A non-transitory computer-readable storage medium with an executable program stored thereon, wherein the program, when executed, instructs one or more computer processors to list an item for sale on an ecommerce system, by performing the following method:
receiving from a seller information delineating the category of the item, the information including an image of the item;
making an image comparison of the image of the item against an image of an item known to be of the delineated category;
detecting whether there is a mismatch between the image of the listed item and the image of the item known to be of the delineated category; and
responsive to the detection of a mismatch, providing feedback to the seller indicating a possible error in categorizing the listed item.

11. The non-transitory computer-readable storage medium of claim 10 wherein at least one of the images is in silhouette form.

12. The non-transitory computer-readable storage medium of claim 10, including using the included image of the item to access the image of the item known to be of the delineated category.

13. A system for improving the categorizing of an item in a listing of the item for sale on an ecommerce system comprising:
a listing server for receiving from a seller information delineating the category of the item, the item including an image of the item;
an accessing circuit coupled to the listing server for making an image comparison of the image of the item against an image of an item known to be of the delineated category, and detecting whether there is a mismatch between the image of the listed item and the image of the item known to be of the delineated category; and
an item listing presentation management module responsive to the detection of a mismatch, for providing feedback to the seller indicating a possible error in categorizing the listed item.

14. The system of claim 13 wherein at least one of the images is in silhouette form.

15. A computer implemented method for improving the categorizing of an item in a listing of the item for sale on an ecommerce system, the method comprising:
receiving from a seller information delineating the category of the item;
responsive to the information, presenting to the seller a plurality of images of types of items of the delineated category;
receiving from the seller a selected one of the plurality of images;
detecting whether the information received from the seller matches the selected one of the plurality of images; and
responsive to detecting that there is a mismatch between the information and the selected one of the plurality of images, providing feedback to the seller indicating a possible error in categorizing the listed item.

16. The computer implemented method of claim 15 wherein the plurality of types of items is in silhouette form.

17. The computer implemented method of claim 16 wherein the silhouette visually depicts one or more attributes possessed by the item.

18. The computer implemented method of claim 17, the attributes including one of shape, form, style, color, and the like.

19. A non-transitory computer-readable storage medium with an executable program stored thereon, wherein the program, when executed, instructs one or more computer processors to list an item for sale on an ecommerce system, by performing the following method:
receiving from a seller information delineating the category of the item;
responsive to the information, presenting to the seller a plurality of images of types of items of the delineated category;
receiving from the seller a selected one of the plurality of images;
detecting whether the information received from the seller matches the selected one of the plurality of images; and
responsive to detecting that there is a mismatch between the information and the selected one of the plurality of images, providing feedback to the seller indicating a possible error in categorizing the listed item.

20. The non-transitory computer-readable storage medium of claim 19 wherein the plurality of images of types of items is in silhouette form.

21. The non-transitory computer-readable storage medium of claim 20 wherein the silhouette visually depicts one or more attributes possessed by the item.

22. The non-transitory computer-readable storage medium of claim 21, the attributes including one of shape, form, style, color, and the like.
